(19) United States
(12) Patent Application Publication
(10) Pub. No.: US 2026/0212110 A1
(43) Pub. Date: Jul. 23, 2026

(54) Speech and Picture Infilling Using Text Editing

(71) Applicant: Google LLC, Mountain View, CA (US)

(72) Inventors: Dirk Ryan Padfield, Seattle, WA (US); Daniel David Walker, IV, Kenmore, WA (US); Matthew Sharifi, Kilchberg (CH); Noah Benjamin Murad, Vancouver (CA); Feifan Chen, Seattle, WA (US); Melissa Lianna Ferrari, Brooklyn, NY (US)

(21) Appl. No.: 19/157,308

(22) PCT Filed: Feb. 15, 2023
(86) PCT No.: PCT/US2023/013097

§ 371 Date: Aug. 15, 2025

(51) Int. Cl. G06F 40/166; G11B 27/031

(52) U.S. Cl. CPC G06F 40/166; G11B 27/031

(57) ABSTRACT

Systems and methods for editing media data are disclosed herein. The method includes receiving a text file and media data, wherein the text file is a transcription of at least a portion of the media data and receiving a request to perform an edit to the media data. The method can also include identifying one or more portions of the text file for modification and determining at least one modification for at least one portion of the one or more portions of the text file. The method can further include performing the at least one modification to the at least one portion of the text file and performing an edit to the media data based on the at least one modification to the at least one portion of the text file.

### FIELD

The present disclosure relates generally to speech and picture infilling. More particularly, the present disclosure relates to performing modifications to media data, such as modifying video and/or audio, generating new audio, and the like, based on edits made to a transcript associated with the media data.

### BACKGROUND

Media creation can involve a myriad of activities, such as requiring multiple takes to correct mistakes, performing editing to achieve desired results, and the like. Specialized and expensive software is often needed to achieve a desirable final product. Furthermore, some media formats (e.g., teleconference videos, extemporaneous audio and/or video such as podcasts, and the like) do not lend themselves to performing multiple takes or do-overs to achieve desired results for the video, especially if one or more persons speaking in the media make mistakes, hesitates, and the like.

### SUMMARY

Aspects and advantages of embodiments of the present disclosure will be set forth in part in the following description, or can be learned from the description, or can be learned through practice of the embodiments.

One example aspect of the present disclosure is directed to A computer-implemented method for editing media data. The method includes receiving, by an electronic processor, a text file and media data, wherein the text file is a transcription of at least a portion of the media data and receiving, by the electronic processor, a request to perform an edit to the media data. The method also includes identifying, by the electronic processor, one or more portions of the text file for modification and determining, by the electronic processor, at least one modification for at least one portion of the one or more portions of the text file. The method further includes performing, by the electronic processor, the at least one modification to the at least one portion of the text file and performing, by the electronic processor, an edit to the media data based on the at least one modification to the at least one portion of the text file.

Another example aspect of the present disclosure is directed to A computing system for editing media data. The computing system includes an electronic processor and a non-transitory, computer readable medium comprising instructions that, when executed by the electronic processor, cause the electronic processor to perform operations. The operations include receiving a text file and media data, wherein the text file is a transcription of at least a portion of the media data and receiving a request to perform an edit to the media data. The operations also include identifying one or more portions of the text file for modification and determining at least one modification for at least one portion of the one or more portions of the text file. The operations can further include performing the at least one modification to the at least one portion of the text file and performing an edit to the media data based on the at least one modification to the at least one portion of the text file.

Another example aspect of the present disclosure is directed to a non-transitory, computer readable medium comprising instructions that, when executed by an electronic processor, cause the electronic processor to perform operations. The operations include receiving a text file and media data, wherein the text file is a transcription of at least a portion of the media data and receiving a request to perform an edit to the media data. The operations also include identifying one or more portions of the text file for modification and determining at least one modification for at least one portion of the one or more portions of the text file. The operations further include performing the at least one modification to the at least one portion of the text file and performing an edit to the media data based on the at least one modification to the at least one portion of the text file.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs media data editing according to example embodiments of the present disclosure.

FIG. 1B depicts a block diagram of an example computing device that performs media data editing according to example embodiments of the present disclosure.

FIG. 1C depicts a block diagram of an example computing device that performs media data editing according to example embodiments of the present disclosure.

FIG. 2 depicts a block diagram of an example data flow for creating edited media data according to one or more example embodiments of the present disclosure.

FIG. 6 depicts a flow chart diagram of an example method to perform XXX according to example embodiments of the present disclosure.

Reference numerals that are repeated across plural figures are intended to identify the same features in various implementations.

### DETAILED DESCRIPTION

### Overview

Generally, the present disclosure is directed to generating new audio and/or video data to perform “infilling,” or replacing original media data (e.g., audio and/or video data) with the generated new audio or video. Given the raw audio and/or video data (hereinafter referred to as “media data”) and an associated transcript for the media data, the invention can determine changes that can be made to the transcript and then propagate these changes through the media data based on the changes being made to the transcript using various machined-learned models, such as models for generating new audio or for stitching audio and video data segments together.

With reference now to the Figures, example embodiments of the present disclosure will be discussed in further detail.

### Example Devices and Systems

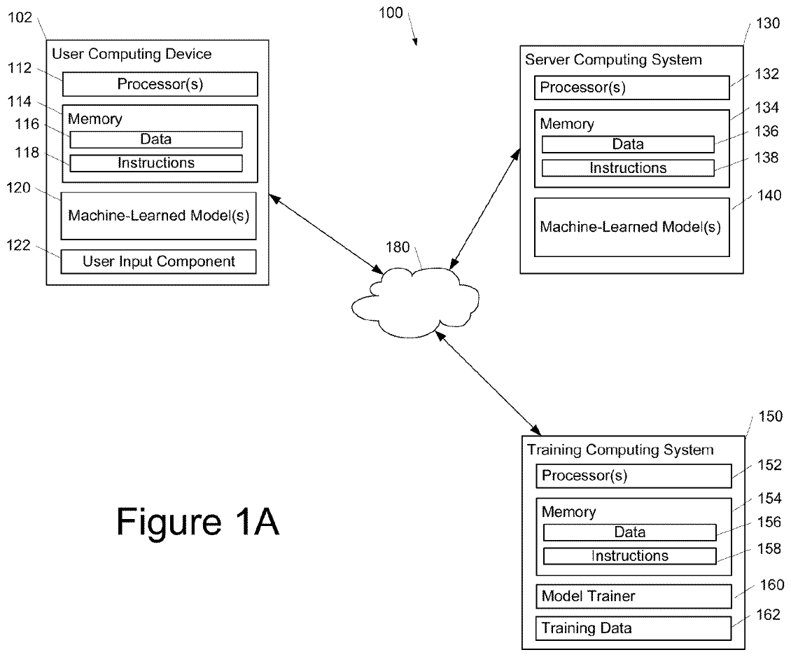

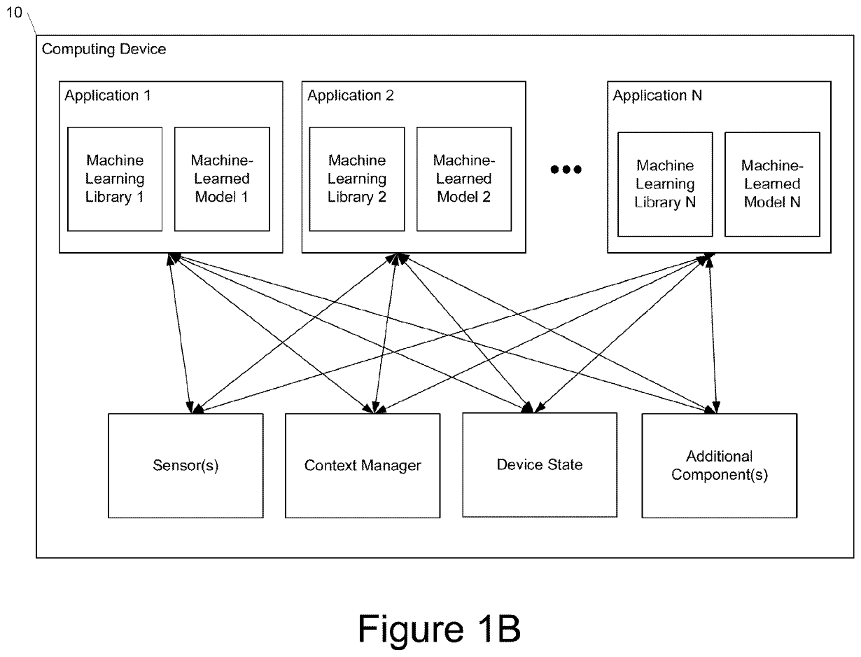

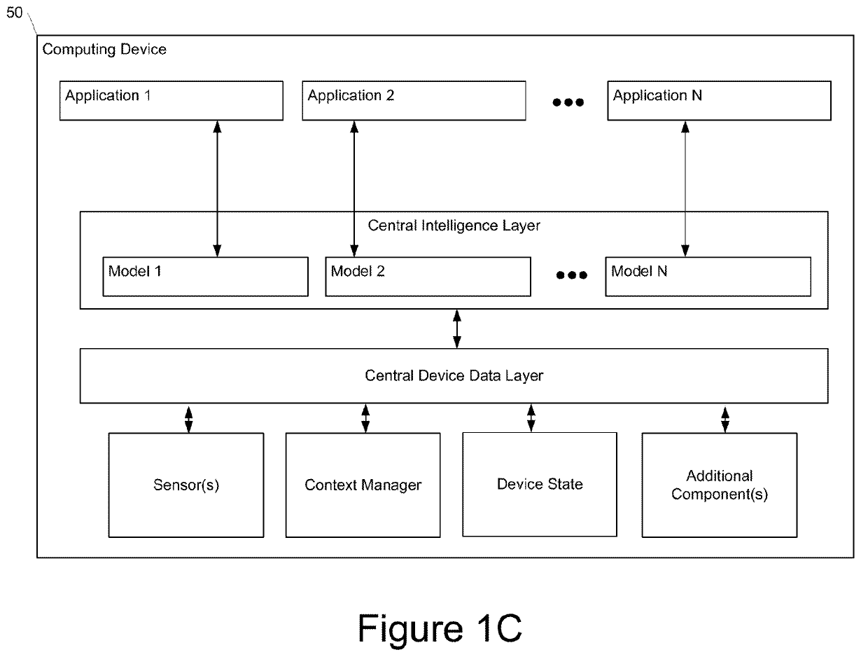

FIG. 1A depicts a block diagram of an example computing system 100 that performs media data editing according to example embodiments of the present disclosure.

The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more media editing models 120. For example, the media editing models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

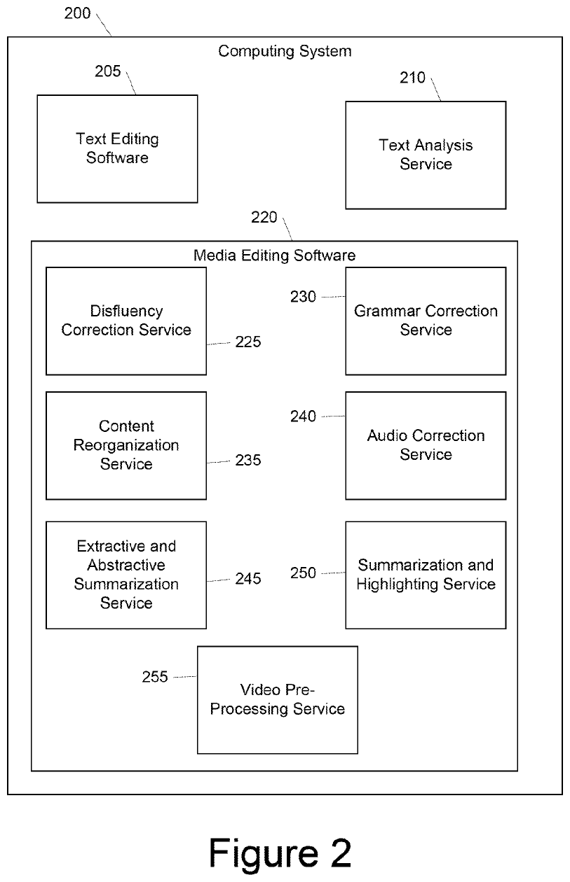

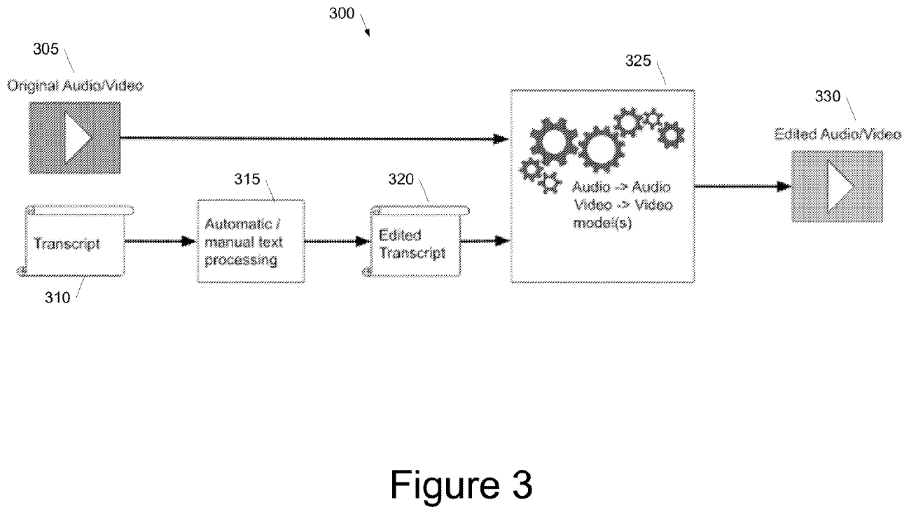

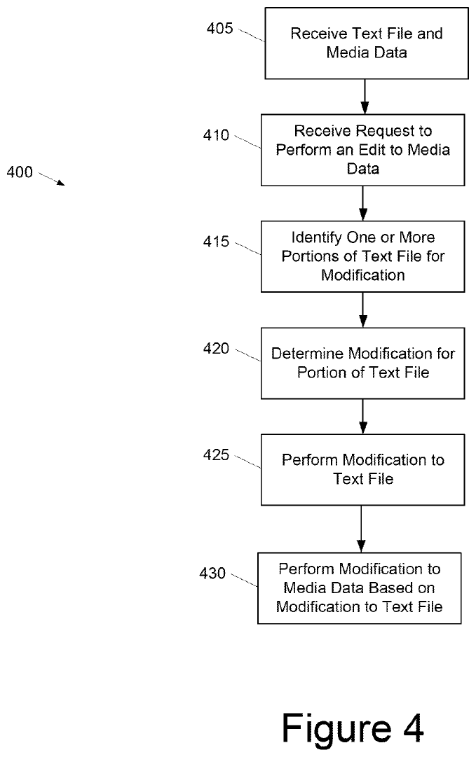

Example media editing models 120 are discussed with reference to FIG. 2.

In some implementations, the one or more media editing models 120 can be received from the server computing system 130 over network 180, stored in the user computing device memory 114, and then used or otherwise implemented by the one or more processors 112. In some implementations, the user computing device 102 can implement multiple parallel instances of a single media editing model 120 (e.g., to perform parallel media editing across multiple instances of media editing).

More particularly, the one or more media editing models 120 allow for the creation of a more refined and polished video for distribution. For example, the one or more media editing models 120 can crop, stitch, and generate audio and video for replacing or otherwise modifying raw input media data to create a more polished or refined audio and/or video data. Additional details can be found below with regards to FIG. 2.

Additionally or alternatively, one or more media editing models 140 can be included in or otherwise stored and implemented by the server computing system 130 that communicates with the user computing device 102 according to a client-server relationship. For example, the media editing models 140 can be implemented by the server computing system 140 as a portion of a web service (e.g., a media editing service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more media editing models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the media editing models 120 and/or 140 based on a set of training data 162. The training data 162 can include, for example, audio and/or video data segments and associated desired outputs (e.g., clipped media segments, cropped media segments, stitched media segments, combined media segments, removed media segments, annotated media segments, and other modified media segments). The media editing models 120 and/or 140 can analyze the modifications made from the original received media data and compare the modifications to the desired outputs.

The model trainer 160 can also train the media editing models using, for example, textual data, such as transcripts for media data. In particular, the model trainer 160 can provide a transcript with a modification made (e.g., a sentence removed, a sentence added, a sentence modified, a sentence moved within the transcript, or other modifications that can be performed on text) and an associated desired media output (e.g., audio and/or video). Based on the modified transcript and the desired media output, the model trainer 160 can train the media editing models 120 and/or 140 to perform media editing actions to achieve the desired media output.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be speech and/or audio data. The machine-learned model(s) can process the speech and/or audio data data to generate an output. As an example, the machine-learned model(s) can process the speech and/or audio data to generate a speech recognition output or audio recognition output. As another example, the machine-learned model(s) can process the speech and/or audio data to generate a speech translation output or audio translation output.

As another example, the machine-learned model(s) can process the speech and/or audio data to generate a latent embedding output. As another example, the machine-learned model(s) can process the speech and/or audio data to generate an encoded speech output (e.g., an encoded and/or compressed representation of the speech data, etc.) or an encoded audio output. As another example, the machine-learned model(s) can process the speech and/or audio data to generate an upscaled speech output (e.g., speech data that is higher quality than the input speech data, etc.) or upscaled audio output. As another example, the machine-learned model(s) can process the speech and/or audio data to generate a textual representation output (e.g., a textual representation of the input speech and/or audio data, etc.). As another example, the machine-learned model(s) can process the speech and/or audio data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Computing System

FIG. 2 depicts a computing system 200 for editing media data according to some embodiments of the present disclosure.

Computing system 200 can include text editing software 205. Text editing software 205 can be a word processing software application or similar software application that allows textual documents to be viewed and edited by a user, such as a transcript for media data.

Text editing software 205 can include text analysis service 210. Text analysis service 210 can perform various analyses on the text of the document being viewed within the text editing software 205 and make recommendations for changes to the text of the document.

For example, text analysis service 210 can perform grammar and punctuation analysis, term usage consistency analysis, flow and narrative analysis, and other analyses.

In some embodiments, text analysis service 210 can perform disfluency detection analysis. In disfluency detection, filler words in a text document are identified (especially in transcripts, where phrases such as “uh,” “uhm,” “hm,” and others are used as placeholders while a speaker considers a point), repetitions of words can be detected, and mistakes (e.g., misspoken words, incorrect grammar during speech, etc.) can be detected. These detected portions of the text can then be recommended for change and/or automatically changed in the transcript.

Text analysis service 210 can also perform extractive summarization. Text analysis service 210 can analyze the entirety of the transcript and build a textual summary of the entirety of the document by, for example, selecting sentences summarizing key points from the transcript. This textual summary can then be added to the transcript or output as its own transcript. In some embodiments, the text analysis service 210 can also perform abstractive summarization, which identifies key pieces of the text and builds new sentences, instead of using existing sentences from the transcript, for a summarization of the transcript.

Text analysis service 210 can further perform video summarization and highlighting. If the transcript includes questions and answers by two or more speakers, the text analysis service 210 can generate text summarizing the question-answer back-and-forth.

Text analysis service 210 can also perform content re-organization. Text analysis service 210 can identify one or more portions of the transcript that are “out-of-place” (e.g., not otherwise associated with the current conversation topic occurring, in reference to a prior question or thought, etc.) and can recommend making changes to move this portion of text to the more relevant portion of the transcript.

The computing system 200 can also include media editing software 220. Media editing software 220 enables the computing system 200 to edit media data in various ways, including based on changes to a transcript associated with the media data.

Media editing software 220 can include disfluency correction service 225. As described above, the text analysis service 210 can perform disfluency detection on the transcript and make recommendations to clean up the transcript to remove superfluous or repeated words and other mistakes in the transcript. Disfluency correction service 225 performs these changes in the media data by, for example, generating new audio, moving and stitching audio or video, and other similar editing actions.

Media editing software 220 can also include grammar correction service 230.

Grammar correction service 230 receives grammar corrections from text analysis service 210 and edits the media data (e.g., deletes the audio with incorrect grammar, generates new audio with correct grammar, and inserts the new audio into the media data) based on the grammar corrections.

Media editing software 220 can also include content re-organization service 235.

Content re-organization service 235 identifies, based on changes recommended by the text analysis service 210, portions of the media data that can be re-organized, or shifted around temporally within the media data to make more logical sense. Content re-organization service 235 can, for example, remove a portion of audio and video from the media data at a first time, identify a different time in the media data where the portion of audio and video would more likely be relevant based on recommendations from the text analysis service 210, and then perform stitching and other audio and video editing techniques to add the portion of audio and video in at the different time in the media data. Content re-organization service 235 can also “clean up” portions of the media data where data has been moved (e.g., when media is moved to a new time, the old time can be stitched together to not have an interruption in the media data).

Media editing software 220 can also include audio correction service 240. Audio correction service 240 can be used to replace audio that is mumbled, distorted, or otherwise of poor quality. Based on the transcript (which may be edited to include a correct term or phrase in case the original transcript was confused as to what was said because of poor audio quality), audio correction service 240 can generate new audio with the correct term or phrase and replace the poor quality audio in the media data.

Media editing software 220 can further include extractive and abstractive summarization service 245. As described above, text analysis software 210 can generate a transcript of an extractive summarization of the media data, which summarizes key points, highlights certain statements, and the like. Based on this transcript, extractive summarization service 245 can identify portions of the media data associated with the portions of the transcript that are part of the summarization and generate new media data with these portions of the original media data stitched together to create the summarization. This summarization can be extractive summarization or abstractive summarization.

Media editing software 220 can also include summarization and highlighting service 250. As described above, text analysis software 210 can identify one or more highlights in the transcript and generate a new transcript capturing these highlights and summarizing the highlights. Summarization and highlighting service 250 can identify the relevant portions of the media data associated with the highlights and generate any new audio and/or video required for the summarization and create new media data using the stitched together portions of the original media data and the newly generated audio and/or video.

Media editing software 220 can also include video pre-processing service 255. Video pre-processing service 255 can edit the media data by, for example, removing dead time at the beginning and end of the media data, removing portions that do not have any audio or video, and other similar functions. This helps to shorten the final media data product, saving storage and processing and transmission costs.

Each of the above-mentioned services can use models for media editing 260. These models can include one or more models that enable the generation of new audio or video, the alignment of audio and video, creating new audio and related “lip syncing” new video, stitching together segments of media data, correcting audio, and the like.

### Example Data Flow

FIG. 3 depicts a block diagram 300 of an example data flow for creating edited media data according to one or more example embodiments of the present disclosure.

Original media data 305 (e.g., audio and/or video data) and an associated transcript 310 can be received. The transcript 310 can be a textual document outlining what is spoken, heard, or otherwise is present in the audio data of the original media data 305.

If a user wishes to make edits to the media data, or if the computing system suggests or highlights potential edits that a user may wish to perform based on its own analysis, the user can initiate a request to edit the transcript, and manual and/or automatic text processing on the transcript can be performed. For example, the user may manually or automatically remove words, add words, perform grammar correction, perform summarization of key topics, shift a time in which a particular comment is made, and others within the text transcript. Edited transcript 320 is the result of the automatic or manual text processing step 315 The original media data 305 and the edited transcript 320 are then fed into a set of media editing models 325 to make edits to the original media data.

Media editing models 325 can include models for e.g., removing portions of media data associated with the portions removed from the transcript, models for stitching new segments together that are newly connected, models for performing lip syncing to match up newly generated audio and video, models for generating audio data to fill gaps of audio in speech samples based on newly input text, models for generating brief audio summaries or visual summaries of the media data based on the transcript, models for removing filler words, repetitions, and mistakes, models for creating an executive summary by selecting portions of the transcript and associated portions of the media data that provide “the overall picture,” models that can reorganize portions of the transcript and/or media data for better narrative flow, models than can correct low-quality audio based on edits to the transcript, and the like.

The final product of the processing of the different models 325 is an edited media file, which is provided back to the user.

### Example Methods

FIG. 4 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system receives a text file and media data. The text file is a transcription of at least a portion of the media data. The media data includes audio and/or video data.

At 404, the computing system receives a request to perform an edit to the media data. In some embodiments, the request is a manual request sent by a user and includes as part of the request identification of one or more portions of the transcript associated with the media data to be changed and, in some embodiments, what types of changes are to be performed to the transcript. In other embodiments, one or more analyses can be automatically performed on the one or more portions of the text file identified in the manual request.

At 406, the computing system identifies one or more portions of the text file for modification. In the case of receiving a manual request from a user, these portions can be identified in the request by the user (e.g., line X, paragraph Y, audio at timestamp Z, and the like). In other embodiments, the computing system can perform one or more analyses of the transcript as a whole to determine portions of the transcript that could be modified.

At 408, the computing system determines at least one modification for at least one portion of the one or more portions of the text file. In the case of a manual request, these types of modifications can already be defined in the received request. In other embodiments, the computing system can, based on the analyses performed in step 406, determine one or more modifications to make to one or more portions of the transcript. In some embodiments, the one or more modifications can include modifications such as disfluency correction, grammar correction, extractive summarization, video summarization and highlighting, content re-organization, video pre-processing, and audio correction. In some embodiments, 14 one or more machine-learned models can take the transcript as input and output a determined modification.

At 410, the computing system performs the at least one modification to the at least one portion of the text file. The computing system edits the transcript and produces an edited transcription with the determined modifications from the previous steps included in the edited transcript.

At 412, the computing system performs an edit to the media data based on the at least one modification to the at least one portion of the text file. For example, based on the edited transcript, the computing system can remove portions of the media data, generate new portions for the media data, change portions of the media data, temporally re-arrange portions of the media data, stitch together portions of media data, and the like. In some embodiments, one or more machine learned models can be used to process the media data and apply the changes indicated in the edited transcript to the media data.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for editing media data, the method comprising:
receiving, by an electronic processor, a text file and media data, wherein the text file is a transcription of at least a portion of the media data;
receiving, by the electronic processor, a request to perform an edit to the media data;
identifying, by the electronic processor, one or more portions of the text file for modification;
determining, by the electronic processor, at least one modification for at least one portion of the one or more portions of the text file;
performing, by the electronic processor, the at least one modification to the at least one portion of the text file; and
performing, by the electronic processor, an edit to the media data based on the at least one modification to the at least one portion of the text file.

2. The method of claim 1, wherein the request is a manual request received as a user input, and wherein the one or more portions of the text file are identified in the manual request as portions for modification.

3. The method of claim 2, wherein the one or more modifications are identified in the manual request.

4. The method of claim 2, wherein determining the at least one modification includes automatically performing one or more analyses on the one or more portions of the text file identified in the manual request to determine a type of modification to be made to the at least one portion of the text file.

5. The method of claim 1, wherein the one or more modifications include at least one modification selected from the group of modifications consisting of disfluency correction, grammar correction, extractive summarization, video summarization and highlighting, content re-organization, video pre-processing, and audio correction.

6. The method of claim 1, wherein determining the at least one modification includes processing, by the electronic processor, the one or more portions of the text file using a machine-learned model.

7. The method of claim 1, wherein performing the edit to the media data includes processing, by the electronic processor, the media data using one or more machine-learned models to apply the at least one modification to a portion of the media data associated with the at least one portion of the text file.

8. A computing system for performing editing media data, the computing system comprising:
an electronic processor; and
a non-transitory, computer readable medium comprising instructions that, when executed by the electronic processor, cause the electronic processor to perform operations, the operations including:
receiving a text file and media data, wherein the text file is a transcription of at least a portion of the media data;
receiving a request to perform an edit to the media data;
identifying one or more portions of the text file for modification;
determining at least one modification for at least one portion of the one or more portions of the text file;
performing the at least one modification to the at least one portion of the text file; and
performing an edit to the media data based on the at least one modification to the at least one portion of the text file.

9. The computing system of claim 8, wherein the request is a manual request received as a user input, and wherein the one or more portions of the text file are identified in the manual request as portions for modification.

10. The computing system of claim 9, wherein the one or more modifications are identified in the manual request.

11. The computing system of claim 9, wherein determining the at least one modification includes automatically performing one or more analyses on the one or more portions of the text file identified in the manual request to determine a type of modification to be made to the at least one portion of the text file.

12. The computing system of claim 8, wherein the one or more modifications include at least one modification selected from the group of modifications consisting of disfluency correction, grammar correction, extractive summarization, video summarization and highlighting, content re-organization, video pre-processing, and audio correction.

13. The computing system of claim 8, wherein determining the at least one modification includes processing the one or more portions of the text file using a machine-learned model.

14. The computing system of claim 8, wherein performing the edit to the media data includes processing the media data using one or more machine-learned models to apply the at least one modification to a portion of the media data associated with the at least one portion of the text file.

15. A non-transitory, computer readable medium comprising instructions that, when executed by an electronic processor, cause the electronic processor to perform operations, the operations including:
receiving a text file and media data, wherein the text file is a transcription of at least a portion of the media data;
receiving a request to perform an edit to the media data;
identifying one or more portions of the text file for modification;
determining at least one modification for at least one portion of the one or more portions of the text file;
performing the at least one modification to the at least one portion of the text file; and
performing an edit to the media data based on the at least one modification to the at least one portion of the text file.

16. The non-transitory, computer readable medium of claim 15, wherein the request is a manual request received as a user input, and wherein the one or more portions of the text file are identified in the manual request as portions for modification.

17. The non-transitory, computer readable medium of claim 16, wherein the one or more modifications are identified in the manual request.

18. The non-transitory, computer readable medium of claim 16, wherein determining the at least one modification includes automatically performing one or more analyses on the one or more portions of the text file identified in the manual request to determine a type of modification to be made to the at least one portion of the text file.

19. The non-transitory, computer readable medium of claim 15, wherein determining the at least one modification includes processing the one or more portions of the text file using a machine-learned model.

20. The non-transitory, computer readable medium of claim 15, wherein performing the edit to the media data includes processing the media data using one or more machine-learned models to apply the at least one modification to a portion of the media data associated with the at least one portion of the text file.
